(19) United States
(12) Patent Application Publication
(10) Pub. No.: US 2026/0127855 A1
(43) Pub. Date: May 7, 2026

(54) MULTIMODAL EMISSIONS MODEL

(71) Applicant: Schlumberger Technology Corporation, Sugar Land, TX (US)

(72) Inventors: Sunil Manikani, Pune (IN); Gian-Marcio Gey, London (GB); Harshada Shirish Modak, Pune (IN)

(21) Appl. No.: 19/375,748

(22) Filed: Oct. 31, 2025

(30) Foreign Application Priority Data
Nov. 1, 2024 (IN) 202411083722

(51) Int. Cl. G06V 10/77; G06N 3/084; G06V 10/74

(52) U.S. Cl. CPC G06V 10/7715; G06N 3/084; G06V 10/761

(57) ABSTRACT

Emission images and emission records are obtained and paired to obtain image-record pairs. A subset of the image-record pairs is selected as a training dataset. For each image-record pair of the training dataset, a tensor embedding of the image is obtained from a vision encoder of a multi-modal large language model. Further, a tensor embedding of the record is obtained from a transformer-based text encoder of the multi-modal large language model. A contrastive learning engine transforms the tensor embeddings into a common embedding space. Image tensor embeddings and record tensor embeddings in the common embedding space to obtain a set of matched image-record pairs and a set of mismatched image-record pairs. The M-LLM is fine-tuned with the set of matched image-record pairs and the set of mismatched image-record pairs.

### CROSS-REFERENCE TO RELATED APPLICATIONS

This application claims benefit to India application No. 202411083722, filed in India on Nov. 1, 2024, and which is incorporated herein by reference.

### BACKGROUND

Oil and gas production and downstream ecosystems face ongoing challenges in detecting and fixing emissions and leaks. Emissions and leaks may lead to operational inefficiencies, environmental damage, and financial losses. Emission and leak detection may entail manual labor, fixed sensors, or conventional image processing. Current detection methodologies may be unsuited to scale up to real-time, automatic leak detection and resolution.

### SUMMARY

In general, emission images and emission records are obtained and paired to obtain image-record pairs. A subset of the image-record pairs is selected as a training dataset. For each image-record pair of the training dataset, a tensor embedding of the image is obtained from a vision encoder of a multi-modal large language model. Further, a tensor embedding of the record is obtained from a transformer-based text encoder of the multi-modal large language model. A contrastive learning engine transforms the tensor embeddings into a common embedding space. Image tensor embeddings and record tensor embeddings in the common embedding space to obtain a set of matched image-record pairs and a set of mismatched image-record pairs. The M-LLM is fine-tuned with the set of matched image-record pairs and the set of mismatched image-record pairs.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows an example workflow, in accordance with one or more embodiments.

FIG. 4 shows an example implementation, in accordance with one or more embodiments.

FIG. 5.1 and FIG. 5.2 show a computing system, in accordance with one or more embodiments.

Like elements in the various figures are denoted by like reference numerals for consistency.

### DETAILED DESCRIPTION

One or more embodiments are directed to fine-tuning a multimodal large language model (M-LLM) to process two data modalities. The data modalities include a hyperspectral emission image modality and a data serialization language modality. The hyperspectral emission image modality may be used for emission images. The data serialization language modality may be for emission records. The data serialization language may be any language that has data serialization, such as a markup language. For example, the data serialization language may be “(‘Yet another markup language’) Ain′t Markup Language” (YAML). In another example, the data serialization language may be Javascript Object Notation (JSON). The emission records may be metadata descriptions of emissions leaks. An emission record may be considered as a log of an emission leak and remediation event. The emission record may include details, for example, the time-stamp when the leak was detected, or identified, the nature of the leak, the personnel that fixed the leak, how the leak was resolved, and other contextual information.

The M-LLM is fine-tuned on hyperspectral emission images paired with corresponding emission records. The outcome of fine-tuning the M-LLM is that the M-LLM learns the relationship between the visual data (i.e., in the emission images) and the textual descriptions (i.e., in the emission records). At runtime, or in the inferencing phase, the M-LLM may analyze new, previously “unseen” hyperspectral images captured in real time at a facility, and respond with the most similar, or likely associated, emission record(s). The emission record(s) may provide baseline information about how similar emissions were handled in the past. The baseline information including personnel, likely cause, the nature of the fix and other details may thus streamline the resolution process of the emission leak. Further the baseline information may serve as a suggestion for fixing detected emissions, minimizing downtime, and environmental impact.

The M-LLM is fine-tuned to process both images (e.g., hyperspectral emission images) and text in the data serialization language. The M-LLM may perform emission detection and resolution by processing the images and text. By associating specific visual cues from hyperspectral data with detailed text records, the system can identify the nature of the emission leak and how to address the emission leak. Thus, the M-LLM may be fine-tuned to analyze input images, and further, natural language descriptions of emissions events. The fine-tuned M-LLM may have capabilities to respond with emission records that are similar to the natural language event descriptions or associated with the input images.

The M-LLM may intercept live data from on-site cameras to continuously monitor for leaks. Additionally, the M-LLM may be deployed in a cloud-based framework for post-analysis of emission leak detection and repair.

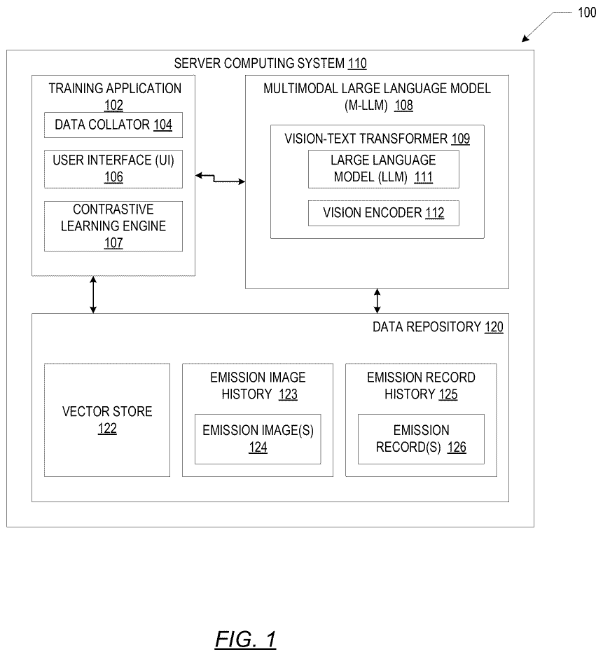

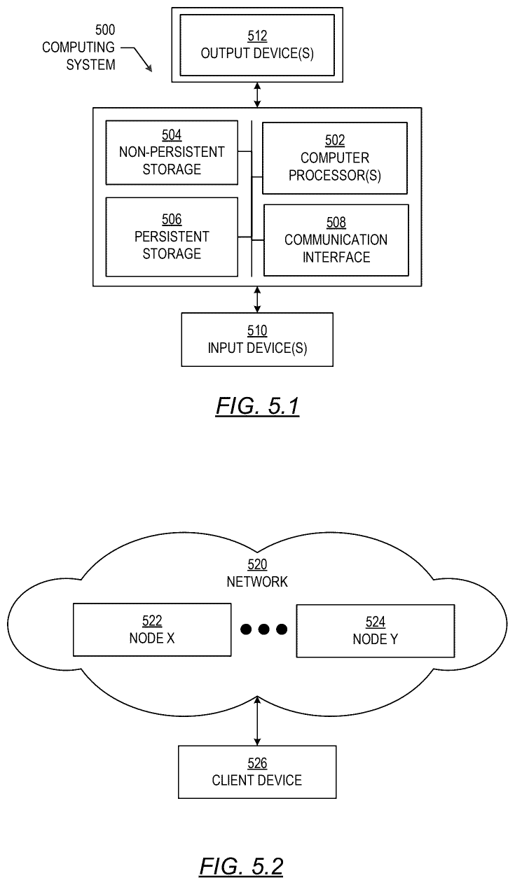

Attention is now turned to the figures. FIG. 1 shows a system diagram (100) of a computing system, in accordance with one or more embodiments. The server computing system (110) shown in FIG. 1 is one or more computer processors, data repositories, communication devices, and supporting hardware and software. The server computing system (110) may be in a distributed computing environment. The one or more computer processors of the server computing system (110) is one or more hardware or virtual processors which may execute computer readable program code that defines one or more applications. The one or more applications may include the multimodal large language model (M-LLM) (108), and the multimodal training application (102). An example of the computer processor is described with respect to the computer processor(s) (502) of FIG. 5.1. An example of a computer system and network that may form the server computing system (110) is described with respect to FIG. 5.1 and FIG. 5.2.

The system shown in FIG. 1 includes a data repository (120). The data repository (120) is a type of logical storage (e.g., a file system, database, data structure, or any other storage mechanism) for storing data. The data repository (120) may reside on multiple different, potentially heterogeneous, physical storage units and/or physical storage devices accessible by a computer system. The data repository (120) includes a vector store (122), an emission image history (123), and an emission record history (125). Each of these components are described herein.

The vector store (122) is a specialized data store designed to store and manage tensor embeddings that are numerical representations of multimodal data. The vector store (122) may include tensor embeddings of emission records and hyperspectral emission images. Raw images, for example, emission images, and human-readable records, for example, emission records, may be numerically represented as tensors. Examples of specialized data storage systems for storing and managing tensors include FACEBOOK® AI Similarity Search (FAISS), MIL VUS®, etc.

Embedding models may convert input data, such as images, and human-readable language content, into numerical representations, called embeddings, in various dimension spaces. Diverse types of embeddings may be obtained from embedding models. For example, a scalar embedding of features or attributes of an entity, such as age, may be obtained from an embedding model. The scalar embedding is a single numerical value representing the feature or attribute of the entity. As another example, a vector embedding of a natural language word, or sentence may be obtained from an embedding model. The vector embedding is a list of numerical values that represents the natural language word or sentence in a multi-dimensional space. In a similar manner, a tensor embedding is a multi-dimensional array of numerical values that may be obtained from an embedding model.

Tensor embeddings generalize scalars, vectors, and matrices to higher dimensions. Thus, a tensor embedding may represent an image. For example, a color image may be represented as a 3D tensor with dimensions corresponding to height, width, and color channels. In a similar manner, a tensor embedding may represent content in human-readable language. For example, a natural language document may be converted into one or more tensor embeddings by an embedding model. The tensor embeddings may represent words and/or sentences of the document.

The emission image history (123) is an image data store that stores multiple emission image(s) (124). An image data store is a specialized storage system designed to manage and process large collections of image files. The emission image history (123) may be optimized to handle large file sizes and diverse formats. Further, the emission image history (123) may store metadata alongside the images for indexing and retrieval functionality. Additionally, the emission image history (123) may have image pre-processing and image management features used by machine learning models. The emission image history (123) may be distributed across multiple storage modes. Examples of image data stores include MATLAB® ImageDatastore, cloud storage for images such as AMAZON® S3, and GOOGLE® Cloud Storage, etc.

The emission record history (125) is a data store for storing and managing emission records. In one or more embodiments, the emission record history (125) may be a document database, storing emission documents. Examples of document databases with features suitable for management and storage of emission documents include MONGODB®, COUCHBASE®, etc. In other embodiments, the emission record history (125) may store the emission records as key-value pairs in key-value stores, for example, REDIS®, AMAZON DYNAMODB®, etc. Additionally, or alternatively, the emission record history (125) may be a simple file storage system storing emission documents, for example, AMAZON® S3, or AZURE® Blob Storage, etc.

The multimodal training application (102) includes a data collator (104) and a user interface (UI) (106). The multimodal training application is a collection of computer readable programs and software code, which, when executing on the one or more computer processors of the server computing system (110) is configured to train and fine-tune the M-LLM (108) to associate or learn the association between an input emission image and a corresponding emission record. The data collator (104) of the multimodal training application (102) may be configured to prepare the training dataset for the M-LLM (108). In one or more embodiments, the data collator (104) may pair an emission image (124) with an emission record (126). The pairing, or association, is learned by the M-LLM (108). The UI (106) of the multimodal training application (102) may be configured to present a training dashboard, via which training parameters of the M-LLM (108) may be configured.

The multimodal training application (102) further includes a contrastive loss function engine (107). The contrastive learning engine (107) performs multimodal alignment between image and text data. Specifically, the contrastive learning engine (107) receives tensor embeddings generated by the vision encoder (112) and the LLM (111). The tensor embeddings may be modality-specific, originating from diverse encoding architectures and possessing distinct structural characteristics.

To further process the tensor embeddings of diverse modalities, the contrastive learning engine (107) may include one or more projection heads. The projection heads are neural network components responsible for transforming diverse modality-specific embeddings into a common embedding space. Thus, the projection heads may also be modality-specific. For example, an image projection head may receive a tensor embedding from the vision encoder (112) and apply a linear layer or a multi-layer perceptron (MLP) to reduce dimensionality and reorient the embedding into a common embedding space, rendering a transformed embedding suitable for comparison. A linear layer performs a weighted transformation of the input tensor (embedding) by multiplying it with a learned weight matrix and adding a bias term, transforming the tensor into the common embedding space. A multi-layer perceptron (MLP) may include stacked multiple linear layers with non-linear activation functions, such as Rectified Linear Unit (ReLU) or Gaussian Error Linear Unit (GELU), for more complex transformations. Similarly, a text projection head may process the tensor embeddings generated by transformer-based text encoders, such as those in the LLM (111), using a separate linear layer or MLP tailored to textual semantics to map the tensors to the common embedding space. The use of modality-specific projection heads ensures that each type of tensor is appropriately normalized and semantically aligned before similarity computation.

The contrastive learning engine (107) may further be configured to compute a similarity score between the projected tensor embeddings in the common embedding space. The similarity score may be calculated using cosine similarity, dot product, or another suitable metric. The similarity score may reflect the semantic closeness of the image and text pair. The contrastive learning engine (107) may further be configured to apply a contrastive loss function to the similarity score to produce a scalar loss value. The scalar loss value is the contrastive loss value, and serves as the training signal for backpropagation through the transformer layers of the LLM (111). Through backpropagation, the M-LLM parameters may be adjusted to learn the association between an emission image and corresponding emission record.

In one or more embodiments, the contrastive learning engine (107) may process batches of training instances rather than individual pairs. Each batch may include multiple image-text pairs, and the contrastive loss function is computed in a way that rewards high similarity between each emission image and its corresponding emission record, while simultaneously penalizing high similarity between the image and non-matching text records from other pairs in the batch. The batch-based training strategy facilitates the M-LLM (108) to learn a an association between an emission image and corresponding emission record in a common embedding space where matched pairs are clustered together, and mismatched pairs are pushed apart. Thereby, the M-LLM's ability to generalize and retrieve semantically relevant information across modalities is improved. For example, let a batch of N training instances be {(x₁,y₁), (x₂,y₂), . . . , (x_{N},y_{N})}, where xᵢ is the image embedding and yᵢ is the text embedding. Each xᵢyᵢ represents a matched pair. That is, the image and record are pre-determined to be matched, for example, by a domain user. For each image embedding xᵢ, the contrastive learning engine (107) may compute a similarity score between xᵢ and its matched text embedding yᵢ. The objective is to maximize this similarity, reinforcing the semantic alignment between the image and its corresponding emission record. At the same time, the contrastive learning engine (107) may compute similarity scores between xᵢ and all other text embeddings yⱼ in the batch where i≠j. These represent mismatched pairs, and the objective is to minimize their similarity, effectively discouraging incorrect associations. The process is symmetric, meaning each text embedding yᵢ is also compared to all image embeddings xⱼ, i≠j, to align each text only with its true image match. Through this batch-based contrastive learning approach, semantically aligned, or matched, image-record pairs may be distinguished from semantically misaligned, or mismatched image-record pairs.

The M-LLM (108) may be a pre-trained, commercially available multimodal large language model, such as HUGGING FACE® Idefics2. The M-LLM (108) includes a vision-text transformer (109), which is a transformer-based architecture designed to process multimodal inputs by integrating visual and textual data. The vision-text transformer (109) includes a vision encoder (112) and a large language model (LLM) (111). The vision encoder (112) processes images. The LLM (111) processes text. In one or more embodiments, the LLM (111) may generate, as output, a tensor embedding of an emission record provided as input. In this scenario, the LLM (111) as a whole, functions as a transformer-based text encoder. Thus, as used in the current specification, the term “transformer-based text encoder” may refer to the LLM (111).

In a deployment phase, the vision-text transformer (109) may receive an emission leak image and a corresponding emission repair record. The image may be processed by the vision encoder (112), which may be a vision transformer or another advanced image encoder, such as one tailored for hyperspectral emission images. A vision transformer operates by dividing the image into smaller patches, treating each patch as a token, and processing these tokens using a transformer encoder to extract visual features. A feature vector of the visual features serves as a tensor embedding of the image. The feature vector, or tensor embedding, may then be mapped to the input space of the large language model (LLM) (111) using one or more modality projection layers. The modality projection layers ensure that the content of the tensor embedding, namely, the visual features represented by the tensor embedding values, are compatible with the format and dimensionality of the text token embeddings. In one or more embodiments, the mapped tensor embedding may be concatenated with a sequence of text embeddings derived from the emission repair record. The combined sequence may then be fed into the LLM (111). The LLM (111) may process the textual data and integrate it with the visual features for downstream tasks such as generating natural language summaries.

In contrast, in a fine-tuning phase, the focus is on aligning the image and text modalities of the M-LLM through contrastive learning. The vision encoder (112) processes the input image and outputs a tensor embedding representing its visual features. Simultaneously, the text encoder, which is part of the LLM (111), processes the emission repair record and produces a corresponding tensor embedding representing its semantic content. These modality-specific embeddings are extracted from the M-LLM, and passed through projection heads within the contrastive learning engine (107) to be mapped into a common embedding space. The contrastive learning engine (107) may then calculate similarity scores of the transformed tensor embeddings, and further apply the contrastive loss function to the similarity scores.

Notably, a goal of fine-tuning the M-LLM is to improve the alignment of the embeddings of a given image-record pair. The contrastive loss function value obtained from the contrastive loss engine (107), is backpropagated through the layers of the LLM (111), while keeping the vision encoder (112) “frozen”. This process causes the embeddings generated by the text encoders of the LLM (111) to better align with the vision encoder-generated embeddings in the common embedding space. On the other hand, a goal of training, or re-training, the M-LLM would be to correct the predicted output of the M-LLM. The training paradigm would be generative in nature and the M-LLM may be trained to produce coherent and contextually appropriate textual outputs conditioned on multimodal inputs. During auto-regressive training, both the vision encoder and the text transformer may be updated. The M-LLM learns to fuse visual and textual information through mechanisms such as cross-attention or token-level integration.

Thus, the distinction between fine-tuning and training of the M-LLM lies in the objective and the nature of the output. Fine-tuning, as described in the present embodiment, focuses on embedding alignment using contrastive loss and does not involve text generation. Training, instead, involves learning to generate text through auto-regressive modeling and typically requires end-to-end optimization of all model components.

Examples of similar vision-text transformers include the vision-text transformers in DEEPMIND®, Flamingo, Large Language and Vision Assistant (LlaVa), Bootstrapping Language-Image Pre-training (BLIP), and OPENAI® Contrastive Language-Image Pre-training (CLIP) models.

While FIG. 1 shows a configuration of components, other configurations may be used without departing from the scope of one or more embodiments. For example, various components may be combined to create a single component. As another example, the functionality performed by a single component may be performed by two or more components.

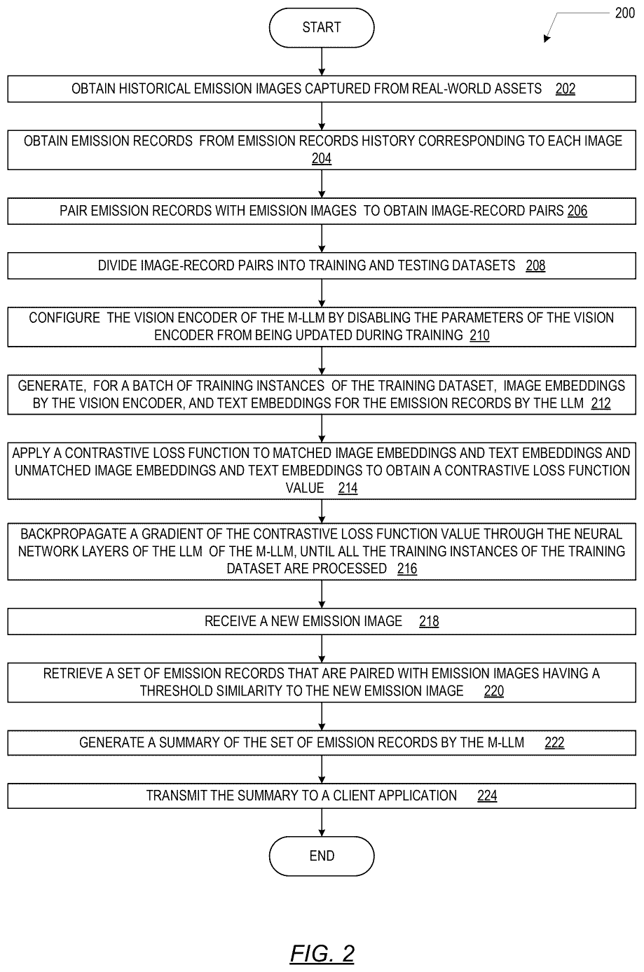

FIG. 2 shows a flowchart 200 of a method for fine-tuning an M-LLM to respond with emission records corresponding to input emission images. The method of FIG. 2 may be implemented using the system of FIG. 1 and one or more of the steps may be performed on or received at one or more computer processors. While the various steps in this flowchart are presented and described sequentially, at least some of the steps may be executed in different orders, may be combined or omitted, and at least some of the steps may be executed in parallel. Furthermore, the steps may be performed actively or passively.

In Block 202, historical emission images captured from real-world assets may be obtained. In one or more embodiments, a multitude of emission images may be obtained from an emission image history in a data repository.

In Block 204, emission records may be obtained from an emission record history, corresponding to each emission image. In one or more embodiments, a multitude of emission records may be obtained from an emission record history in a data repository. The emission records may be pre-defined emission records. In other embodiments, the multimodal training application may generate emission records corresponding to emission images, in natural language or other formats. The generated or obtained emission records and corresponding emission images may be passed to the data collator of the multi-modal training application.

In one or more embodiments, there may be a many-to-one mapping between emission records and emission images. That is, more than one emission record may correspond to an emission image. For example, a hyperspectral image of a methane leak, EI₁ may be received from an oil and gas site. A first emission record, ER₁, may be generated by personnel, logging the event, and the individuals or teams that worked on the methane leak and repaired the leak. A second emission record, ER₂, may be generated, as to the method employed to repair the leak, further including the materials, cost and labor to repair the leak. A third emission record, ER₃, may be generated as to the reason(s) of the cause of the leak, via root-cause analysis, diagnostics, and other methods. Thus, each of the first, second, and third emission records of the example may correspond to the hyperspectral image of the methane leak.

In Block 206, emission records may be paired with corresponding emission images to obtain image-record pairs. In one or more embodiments, emission records of the multitude of emission records may be paired with emission images of the multitude of emission images to obtain a multitude of image-record pairs. In one or more embodiments, the data collator may perform the step of Block 206. For example, the data collator may orchestrate the emission images and emission records in a storage, and link an emission record to an emission image by a key field. Continuing with the previous example, three image-record pairs may be obtained by pairing ER₁, ER₂, and ER₃ with EI₁, namely, EI₁-ER₁, EI₁-ER₂, and EI₁-ER₃.

In Block 208, the image-record pairs may be divided into testing and training datasets. In one or more embodiments, an image-record pair training dataset may be selected from the multitude of image-record pairs by the training application.

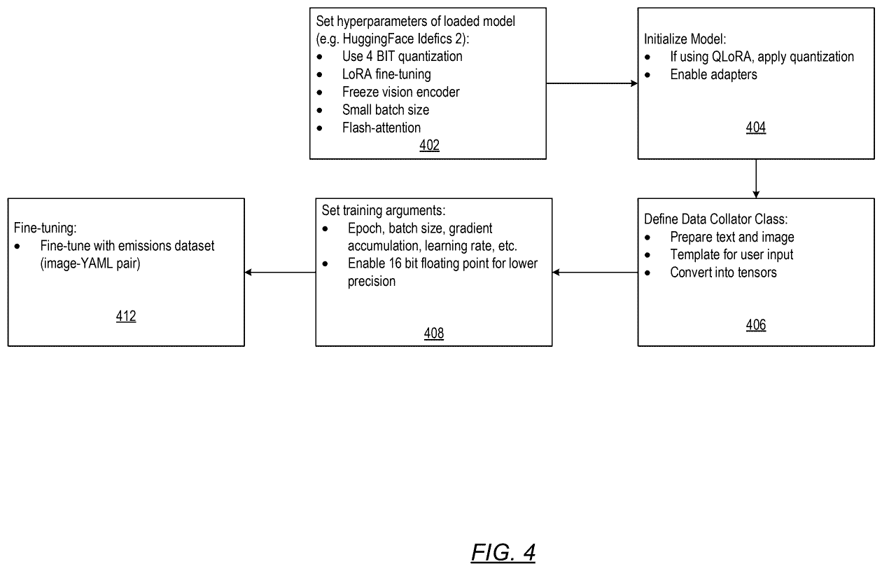

Blocks 210-216 encompass steps of configuring and fine-tuning the M-LLM with the training dataset. In one or more embodiments, the multimodal large language model (M-LLM) may be fine-tuned with the image-record pair training dataset to output a predicted emission record corresponding to an input emission image, based on a multitude of features of the input emission image and predicted emission record, to obtain a fine-tuned M-LLM. In one or more embodiments, the training application may orchestrate configuring and fine-tuning the M-LLM. An implementation of the fine-tuning process of the M-LLM is shown in FIG. 4.

In Block 210, the vision encoder of the M-LLM may be configured by disabling parameters of the vision encoder from being updated during training. In one or more embodiments, the parameters may include weights and biases of neural network layers of the vision encoder.

In Block 212, for a training instance of the training dataset, an image embedding may be generated for the image by the vision encoder, and a text embedding may be generated for the emission record by the transformer-based text encoder. In one or more embodiments, a first tensor embedding may be obtained corresponding to an image of the image-record pair, and a second tensor embedding may be obtained corresponding to a record of the image-record pair.

In Block 214, a contrastive loss function may be applied to the image embedding and the text embedding to obtain a contrastive loss function value. In one or more embodiments, the contrastive loss function may be computed using the first tensor embedding and the second tensor embedding. More particularly, the contrastive loss function may be applied to a similarity score obtained by calculating a similarity measure of the first tensor embedding and the second tensor embedding. In one or more embodiments, the contrastive learning engine may transform the first and second tensor embeddings by mapping the first and second tensor embeddings to a common embedding space. The contrastive learning engine may then compute a similarity score of the transformed first and second embeddings. Subsequently, the contrastive learning engine may apply a contrastive loss function to the similarity score to obtain a scalar loss value as the contrastive loss function value. The contrastive loss function may cause the M-LLM to learn the association between the image features and the corresponding emission record features. The contrastive loss function may cause the model to minimize the distance between the emission-image pairs while maximizing the distance between non-paired emission records and emission images. In other embodiments, a similarity score loss may be implemented to measure the efficacy of the M-LLM in matching the correct emission record to an emission image.

Accordingly, in one or more embodiments, the contrastive learning engine may transform the first tensor embedding and the second tensor embedding into a common embedding space. Further, the contrastive learning engine may calculate similarity scores between matched image-record pairs and mismatched image-record pairs. Furthermore, the contrastive learning engine may apply a contrastive learning function to the similarity scores to compute a contrastive loss function value.

In Block 216, a gradient of the contrastive loss function value may be backpropagated through neural network layers of the transformer-based text encoder of the M-LLM, until all training instances of the training dataset are processed. In one or more embodiments, parameters of a multitude of neural network layers of the M-LLM may be updated by backpropagating the gradient of the contrastive loss function value through the multitude of neural network layers of the M-LLM. The neural network layers may include the neural network layers of the LLM (which functions as the transformer-based text encoder) of the M-LLM. Additionally, in some embodiments, weights and biases of neural network layers of other components of the M-LLM may be updated. In contrast to the vision encoder of the M-LLM where the parameters are disabled from being updated, the parameters of the LLM and other neural network layers may not be disabled from being updated.

In one or more embodiments, once the training process has been completed, the M-LLM may be evaluated using the testing dataset. The frequency of the M-LLM correctly identifying the correct emission record for a given image may be measured. In one or more embodiments, diverse metrics, for example, precision, recall, F1 score, mean squared error (MSE), Area Under the Receiver Operating Characteristic Curve (AUC-ROC), etc. may be used to evaluate the M-LLM. Subsequently, the fine-tuned M-LLM may be deployed.

In Block 218, a new emission image may be received. In one or more embodiments, the fine-tuned M-LLM that is deployed may receive the new emission image from a client application.

In Block 220, a set of emission records may be retrieved. The set of emission records may have been paired with emission images having a threshold similarity to the new emission image. In one or more embodiments, a new image embedding may be generated by the vision encoder of the fine-tuned M-LLM, and the new image embedding may be compared to a multitude of image embeddings in the data repository. The new image embedding, and the multitude of image embeddings may be tensor embeddings. The multitude of image embeddings may correspond to the multitude of emission images of the emission image history in the data repository. A set of image embeddings may be identified that satisfy a similarity threshold with respect to the new image embedding. In one or more embodiments, similarity may be measured by evaluating a cosine similarity function between the emission image embedding and the generated new emission image embedding. Other similarity functions may be used, for example, Euclidean similarity, or dot product similarity. A set of emission record embeddings may be selected that are paired with the identified set of image embeddings. The set of emission record embeddings may be transmitted to the M-LLM. The new emission image embedding may also be transmitted to the M-LLM.

In one or more embodiments, the new image embedding may be mapped by one or more modality projection layers of the M-LLM to the input space of the LLM. Further, the set of emission record embeddings may be mapped by the modality projection layers of the M-LLM to the input space of the LLM. Further, the mapped new image embedding may be concatenated with the mapped emission record embeddings, serving as the input to the LLM. The fine-tuning of the M-LLM serves to align image and text embeddings in a shared semantic space (common embedding space) and to interpret their combined meaning when presented together. The modality projection layers ensure that both types of embeddings are compatible with the LLM's token processing pipeline, allowing the model to treat them as part of a coherent input sequence during generation.

In Block 222, a summary of the set of emission records may be generated by the M-LLM. In one or more embodiments, the M-LLM may generate a natural language summary of emission records corresponding to the set of emission record embeddings.

In Block 224, the summary may be transmitted to a client application. In one or more embodiments, the natural language summary may be transmitted to the client application. An example of a client application may be a repair and maintenance application of a predictive analytics and diagnostic platform for asset management.

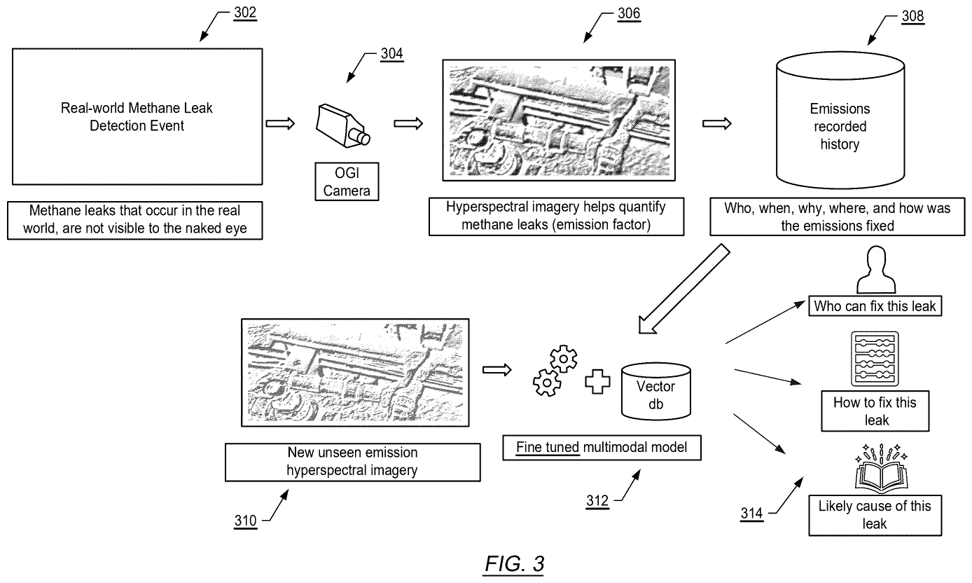

FIG. 3 shows an example workflow where methane leaks are detected using hyperspectral imagery, quantified, and recorded in a database. A multimodal model processes the data to identify solutions including who can fix the leak, how to fix it, and the likely cause.

In Block 302, methane leaks, which are invisible to the naked eye, are detected in the real world. In Block 304, a camera (e.g., an Optical Gas Imaging (OGI) camera) or similar type of instrument is used to detect these leaks. Block 306 shows a hyperspectral image captured by the OGI to quantify methane leaks. This image may provide detailed information, allowing the computation of emission factors (quantifying the methane leaks). In Block 308, the hyperspectral image, along with information about the leak, may be stored in the emission record history and emission image history. The recorded data may include one or more records describing the history of emission leaks, capturing key details such as “who, when, why, where, and how” the emissions were fixed. Block 310 shows a previously unseen emission image, generated using hyperspectral imaging technology. In Block 312, the fine-tuned M-LLM may retrieve emission records related to emission images similar to the previously unseen emission image. The M-LLM may connect to the vector store storing tensor embeddings of the emission records and emission images to retrieve the emission records. Block 314 shows an example of the information that may be obtained from the emission record associated with similar emission images to the previously unseen image.

FIG. 4 shows an example implementation of fine-tuning the M-LLM. One example of an M-LLM is Hugging Face Idefics2. Initially, as shown in Block 402, hyperparameters for the M-LLM are set. The vision encoder is “frozen,” meaning that the vision encoder is not fine-tuned through backpropagation and further optimization. In other words, the vision encoder is treated as a “black box.” The parameters of neural network layers of the vision encoder may be disabled from being updated. Further, low-rank adaption (LoRA) is applied to the Idefics2 model. LoRA fine-tuning is a technique used to fine-tune large language models, by adding a small number of trainable parameters to the model. Applying the LoRA technique may reduce the computational resources and time taken for fine-tuning precluding degradation of performance. Additionally, flash-attention is applied to the M-LLM. Flash-attention is an algorithm for optimizing the attention mechanism in transformer models. Flash-attention accelerates the attention computation and reduces memory usage by reordering the computation and leveraging techniques like tiling and re-computation. Integrating flash-attention may speed up tasks that require high computational resources, such as image-text interactions.

In Block 404 of FIG. 4, the M-LLM model is initialized and adapters for LoRA are enabled. In one or more embodiments, a variation of LoRA, namely, quantized low-rank adaption (QLoRA) may be applied to the M-LLM. In QLoRA, the model weights are quantized to lower precision. Quantization refers to the process of reducing the precision of the M-LLM's weights from higher-bit values (e.g., 16-bit or 32-bit) to lower-bit values (e.g., 4-bit) with a goal to reduce the memory footprint and computational requirements of the M-LLM. Further, adapters for the M-LLM may be enabled, or activated. Adapters refer to small, trainable modules added to the M-LLM to facilitate fine-tuning. Enabling adapters entails activating the adapters. When the adapters are activated, the M-LLM model may adapt to new tasks or datasets with minimal modifications to the original model weights, facilitating efficient and scalable fine-tuning.

In Block 406 of FIG. 4, the data collator is initialized. The textual data and image data may be converted into tensors. In Block 408, various training parameters are configured, for example, epoch length, batch size, learning rate, etc. Thereafter, the model is fine-tuned and evaluated, as shown in Blocks 410 and 412.

The current specification presents a system and method for automated, real-time detection using hyperspectral imaging. By using hyperspectral imaging combined with emission records, the system facilitates real-time, automated analysis and retrieval of historical repair information, accelerating response times and reducing environmental and operational risks. The retrieved historical repair records may provide detailed guidance on how to fix leaks. The system leverages hyperspectral imaging to automatically detect emissions in real time, eliminating the need for manual inspection and ensuring faster identification of leaks. By retrieving matched emission records that include detailed information on previous repair interventions, the M-LLM may identify patterns and provide specific recommendations tailored to a current case. Maintenance teams may thus have access to immediate actionable steps for addressing leaks. As a result, downtime associated with diagnosis of the emission source may be minimized, facilitating reduced operational disruption. The M-LLM continuously learns from new data, preserving expertise and repair history, ensuring that valuable knowledge is retained and accessible in the event of changes of personnel.

Further, the system may be deployed for automated emission detection in chemical plants, refineries, or factories to identify hazardous leaks early and provide repair recommendations. For example, autonomous drones may be used for methane surveillance in an oil and gas production facility to gather real-world, real-time emission images. These images may be passed into a cloud computing environment for further processing. Regulatory compliance may be achieved by tracking and reporting emissions and ensuring that facilities meet environmental standards with historical data for audits.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a plurality of emission images and a plurality of emission records;
pairing emission records of the plurality of emission records with emission images of the plurality of emission images to obtain a plurality of image-record pairs;
selecting, from the plurality of image-record pairs, a subset of the plurality of image-record pairs as a training dataset;
for each image-record pair of the training dataset,
obtaining, from a vision encoder of a multi-modal large language model (M-LLM), a first tensor embedding corresponding to an emission image of the image-record pair,
obtaining, from a transformer-based text encoder of the M-LLM, a second tensor embedding corresponding to an emission record of the image-record pair, and
transforming, by a contrastive learning engine, the first tensor embedding and the second tensor embedding into a common embedding space;
matching pairs using the first tensor embedding and the second tensor embedding in the common embedding space to obtain a set of matched image-record pairs and a set of mismatched image-record pairs; and
fine-tuning the M-LLM with the set of matched image-record pairs and the set of mismatched image-record pairs.

2. The method of claim 1, further comprising:
calculating, by the contrastive learning engine, a plurality of similarity scores between the set of matched image-record pairs and the set of mismatched image-record pairs; and
applying, by the contrastive learning engine, a contrastive learning function to the plurality of similarity scores to compute a contrastive loss function value,
wherein fine-tuning the M-LLM is by backpropagating a gradient of the contrastive loss function value through a plurality of neural network layers of the M-LLM.

3. The method of claim 1, wherein the M-LLM performs operations comprising:
extracting, by the vision encoder, a plurality of features from an emission image; and
generating a feature vector of the plurality of features as a tensor embedding of the emission image.

4. The method of claim 1, further comprising:
obtaining, from the M-LLM, a first plurality of tensor embeddings corresponding to the plurality of emission images;
storing the first plurality of tensor embeddings in a data repository;
generating a second plurality of tensor embeddings, corresponding to the plurality of emission records; and
storing the second plurality of tensor embeddings in the data repository, wherein the second plurality of tensor embeddings is paired with the first plurality of tensor embeddings according to the plurality of image-record pairs.

5. The method of claim 1, further comprising:
configuring the vision encoder of the M-LLM by disabling a plurality of parameters of neural network layers of the vision encoder from being updated during fine-tuning, wherein the plurality of parameters comprises weights and biases of the neural network layers of the vision encoder.

6. The method of claim 1, further comprising:
updating a plurality of parameters of a plurality of neural network layers of the transformer-based text encoder of the M-LLM, by backpropagating a gradient of the contrastive loss function value through the plurality of neural network layers of the transformer-based text encoder, wherein the plurality of parameters is not disabled from being updated.

7. The method of claim 1, further comprising:
receiving a new emission image from a client application;
generating, by the vision encoder of the fine-tuned M-LLM, a new image embedding corresponding to the new emission image, wherein the new image embedding is a tensor embedding; and
comparing the new image embedding to a plurality of image embeddings in a data repository, wherein the plurality of image embeddings are tensor embeddings corresponding to the plurality of emission images.

8. The method of claim 7, further comprising:
identifying a set of image embeddings of the plurality of image embeddings, wherein the set of image embeddings each satisfies a similarity threshold with respect to the new image embedding;
selecting a set of emission record embeddings, wherein the set of emission record embeddings are paired with the set of image embeddings; and
transmitting the set of emission record embeddings to the M-LLM.

9. The method of claim 8, further comprising:
generating, by the M-LLM, using the set of emission record embeddings, a natural language summary of emission records corresponding to the set of emission record embeddings; and
transmitting the natural language summary to the client application.

10. The method of claim 1, wherein the plurality of emission images is obtained from an emission image history in a data repository.

11. A system, comprising:
at least one computer processor;
a multimodal large language model (M-LLM), executing on the at least one computer processor; and
a multimodal training application, executing on the at least one computer processor and configured for performing operations comprising:
obtaining a plurality of emission images and a plurality of emission records from a data repository,
pairing emission records of the plurality of emission records with emission images of the plurality of emission images to obtain a plurality of image-record pairs,
selecting, from the plurality of image-record pairs, a subset of the plurality of image-record pairs as a training dataset;
for each image-record pair of the training dataset,
obtaining, from a vision encoder of the M-LLM, a first tensor embedding corresponding to an emission image of the image-record pair,
obtaining, from a transformer-based text encoder of the M-LLM, a second tensor embedding corresponding to an emission record of the image-record pair, and
transforming, by a contrastive learning engine of the training application, the first tensor embedding and the second tensor embedding into a common embedding space;
matching pairs using the first tensor embedding and the second tensor embedding in the common embedding space to obtain a set of matched image-record pairs and a set of mismatched image-record pairs; and
fine-tuning the M-LLM with the set of matched image-record pairs and the set of mismatched image-record pairs.

12. The system of claim 11, wherein the M-LLM performs operations comprising:
extracting, by the vision encoder, a plurality of features from an emission image; and
generating a feature vector of the plurality of features as a tensor embedding of the emission image.

13. The system of claim 11, wherein the operations further comprise:
obtaining, from the M-LLM, a first plurality of tensor embeddings corresponding to the plurality of emission images;
storing the first plurality of tensor embeddings in a data repository;
generating a second plurality of tensor embeddings, corresponding to the plurality of emission records; and
storing the second plurality of tensor embeddings in the data repository, wherein the second plurality of tensor embeddings is paired with the first plurality of tensor embeddings according to the plurality of image-record pairs.

14. The system of claim 11, wherein the operations further comprise:
configuring a vision encoder of the M-LLM by disabling a plurality of parameters of neural network layers of the vision encoder from being updated during fine-tuning, wherein the plurality of parameters comprises weights and biases of the neural network layers of the vision encoder.

15. The system of claim 11, wherein the operations further comprise:
updating a plurality of parameters of a plurality of neural network layers of the M-LLM by backpropagating a gradient of the contrastive loss function value through the plurality of neural network layers of the M-LLM, wherein the plurality of parameters is not disabled from being updated.

16. The system of claim 11, wherein the operations further comprise:
receiving a new emission image from a client application;
generating, by the vision encoder of the fine-tuned M-LLM, a new image embedding corresponding to the new emission image, wherein the new image embedding is a tensor embedding; and
comparing the new image embedding to a plurality of image embeddings in the data repository, wherein the plurality of image embeddings are tensor embeddings corresponding to the plurality of emission images.

17. The system of claim 16, wherein the operations further comprise:
identifying a set of image embeddings of the plurality of image embeddings, wherein the set of image embeddings each satisfies a similarity threshold with respect to the new image embedding;
selecting a set of emission record embeddings, wherein the set of emission record embeddings are paired with the set of image embeddings; and
transmitting the set of emission record embeddings to the M-LLM.

18. A non-transitory computer readable medium comprising computer readable program code for causing a computer system to perform operations comprising:
obtaining a plurality of emission images and a plurality of emission records;
pairing emission records of the plurality of emission records with emission images of the plurality of emission images to obtain a plurality of image-record pairs;
selecting, from the plurality of image-record pairs, a subset of the plurality of image-record pairs as a training dataset;
for each image-record pair of the training dataset,
obtaining, from a vision encoder of a multi-modal large language model (M-LLM), a first tensor embedding corresponding to an emission image of the image-record pair,
obtaining, from a transformer-based text encoder of the M-LLM, a second tensor embedding corresponding to an emission record of the image-record pair, and
transforming, by a contrastive learning engine, the first tensor embedding and the second tensor embedding into a common embedding space;
matching pairs using the first tensor embedding and the second tensor embedding in the common embedding space to obtain a set of matched image-record pairs and a set of mismatched image-record pairs; and
fine-tuning the M-LLM with the set of matched image-record pairs and the set of mismatched image-record pairs.

19. The non-transitory computer readable medium of claim 18, wherein the operations further comprise:
receiving a new emission image from a client application;
generating, by a vision encoder of the fine-tuned M-LLM, a new image embedding corresponding to the new emission image, wherein the new image embedding is a tensor embedding;
comparing the new image embedding to a plurality of image embeddings in a data repository, wherein the plurality of image embeddings are tensor embeddings corresponding to the plurality of emission images; and
identifying a set of image embeddings of the plurality of image embeddings, wherein the set of image embeddings each satisfies a similarity threshold with respect to the new image embedding.

20. The non-transitory computer readable medium of claim 19, wherein the operations further comprise:
selecting a set of emission record embeddings from the data repository, wherein the set of emission record embeddings are paired with the set of image embeddings;
generating, by the fine-tuned M-LLM, using the set of emission record embeddings, a natural language summary of emission records corresponding to the set of emission record embeddings; and
transmitting the natural language summary to the client application.
